(19) United States
(12) Patent Application Publication
(10) Pub. No.: US 2014/0258472 A1
(43) Pub. Date: Sep. 11, 2014

(54) Video Annotation Navigation

(71) Applicant: CBS Interactive Inc., San Francisco, CA (US)

(72) Inventor: Andrew Shirey, San Francisco, CA (US)

(73) Assignee: CBS Interactive Inc., San Francisco, CA (US)

(21) Appl. No.: 14/196,882

(22) Filed: Mar. 4, 2014

Related U.S. Application Data
(60) Provisional application No. 61/773,649, filed on Mar. 6, 2013.

(51) Int. Cl. H04L 29/06

(52) U.S. Cl. CPC H04L 65/60
USPC 709/219

(57) ABSTRACT

A video server assigns topics to portions of a video based on the content of the video. The video is requested by a client device and streamed to the client device for playback. The assigned topics are transmitted to the client device and displayed during video playback as a table of contents and/or a topic treadmill. The table of contents is displayed alongside the video listing each of the topics assigned to a portion of the video. The topic treadmill lists the topics associated with portions of the video that are near the current playback location. The table of contents allows a viewer to jump directly to a portion of a video by interacting with an assigned topic listed in the table of contents. The topic treadmill allows the user to view content associated with the topic.

### RELATED APPLICATIONS

This application claims the benefit of U.S. Provisional Application No. 61/773,649 entitled “Video Annotation Navigation” to Andrew Shirey filed on Mar. 6, 2013, the contents of which are incorporated by reference herein.

### BACKGROUND

1. Field of Art

The disclosure generally relates to the field of video playback. More specifically, the disclosure relates to navigating videos through annotations.

2. Description of Art

Web-based delivery of video content has become an increasingly popular form of content delivery for many content providers. For example, a number of content providers offer digital video content that can be streamed to network-enabled devices such as personal computers, television set-top boxes and mobile devices (e.g., smart phones). Video content can be of significant length and cover a broad range of topics. While a viewer is given the ability to scrub, or manually rewind or fast forward, through a video, the viewer cannot always quickly identify portions of the video relevant to a topic of interest. Further the viewer is not able to easily jump to a portion of the video associated with a topic of interest. This can increase the amount of time needed for a user to watch portions of a video of interest.

Additionally, viewers are not provided a convenient method of locating and consuming content related to a topic that is associated with a portion of the video. This reduces the potential amount of engagement between the viewer and the provider of the video content.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates an embodiment of a computing environment for providing annotation based video navigation to one or more clients.

FIG. 2 illustrates a detailed view of an annotation server according to one embodiment.

FIG. 3 illustrates a detailed view of the video server according to one embodiment.

FIG. 4 illustrates a detailed view of a client according to one embodiment.

FIG. 5 illustrates an embodiment of a process for selecting topics by annotation server for playback on a client.

FIG. 6 illustrates an embodiment of a process for streaming videos and associated topic information to a client.

FIG. 7 illustrates an example annotation user interface in accordance with one embodiment.

FIG. 8 illustrates an example annotation user interface with mouseover links in accordance with one embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will be made in detail to several embodiments, examples of which are illustrated in the accompanying figures. It is noted that wherever practicable similar or like reference numbers may be used in the figures and may indicate similar or like functionality. The Figures depict embodiments of the disclosed system (or method) for purposes of illustration only. One skilled in the art will readily recognize from the following description that alternative embodiments of the structures and methods illustrated herein may be employed without departing from the principles described herein.

### Overview of Example Embodiments

A first example embodiment includes a computer-implemented method for providing topic based navigation. A video server receives a video and transcribes speech from the video. The transcription is analyzed to generate a plurality of topics, each of the plurality of topics associated with a portion of the video. Responsive to receiving a request for the video from a client computer, the video is transmitted to the client and the video playback location is monitored. A topic associated with the current video playback location of the video is determined and the client computer is caused to display the topic associated with the current video playback location of the video. Upon detecting an interaction with the displayed topic associated with the current video playback location on the client computer, the video server identifies related content information based on, for example, sentiment analysis of the topic, associated content, or other factors. The related content information is transmitted to the client computer allowing the client to access the associated content.

Thus, the method beneficially provides topic based navigation that allows the user to access content related to a current portion of video. In another embodiment, the identified topics allow a user to quickly navigate to relevant portions of the video.

### System Architecture

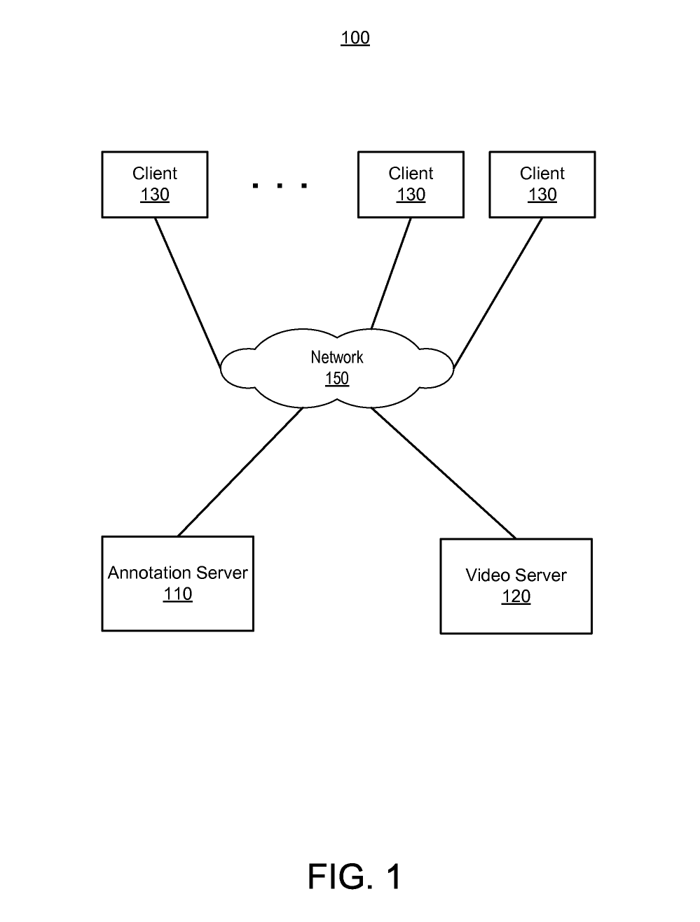

FIG. 1 is a high level block diagram illustrating an example computing environment 100 for providing annotation based navigation according to one embodiment. An annotation server 110 and a video server 120 are coupled to each other and/or to one or more clients 130 via a network 150. Only a single instance of the annotation server 110 and the video server 120 are shown along with three clients 130 in FIG. 1 in order to simplify and clarify the description. However, embodiments of the computing environment 100 can have thousands or millions of clients 130 as well as multiple annotation servers 110 and/or video servers 120. Furthermore, in one embodiment, the annotation server 110 and the video server 120 may be combined in a common server architecture.

The network 150 enables communications among the entities connected to it. In one embodiment, the network 150 is the Internet and uses standard communications technologies and/or protocols. At least a portion of the network 150 can comprise a mobile (e.g., cellular or wireless) data network such as those provided by wireless carriers, for example, VERIZON, AT&T, T-MOBILE, SPRINT, O2, VODAPHONE, and other wireless carriers. In some embodiments, the network 150 comprises a combination of communication technologies. The network 150 can include links using technologies such as Ethernet, 802.11, worldwide interoperability for microwave access (WiMAX), long term evolution (LTE), 3G, 4G, digital subscriber line (DSL), asynchronous transfer mode (ATM), InfiniBand, PCI Express Advanced Switching, etc. Similarly, the networking protocols used on the network 150 can include multiprotocol label switching (MPLS), transmission control protocol/Internet protocol (TCP/IP), User Datagram Protocol (UDP), hypertext transport protocol (HTTP), hypertext transfer protocol secure (HTTPS), simple mail transfer protocol (SMTP), file transfer protocol (FTP), etc. The data exchanged over the network 150 can be represented using technologies and/or formats including hypertext markup language (HTML) (e.g., HTML 5), extensible markup language (XML), etc. In addition, all or some of links can be encrypted using encryption technologies such as the secure sockets layer (SSL), transport layer security (TLS), virtual private networks (VPNs), Internet Protocol security (IPsec), etc. In another embodiment, the entities use custom and/or dedicated data communications technologies instead of, or in addition to, the ones described above.

The video server 120 provides media content to the clients 130. For example, in one embodiment, the video server 120 receives a request for a particular content segment. The video server 120 provides the requested segment to the requesting client 130. The video server 120 receives raw media (e.g., a media file such as a video file or a live audio/video input) from a content source and processes the raw media to generate a format suitable for streaming. While the video server receives and streams or otherwise transmits video content according to one embodiment, the disclosure may also be applicable to audio content. For example, an audio podcast may be annotated in order to enhance viewer navigation in a similar manner. In one embodiment, video server 120 may further transcode the media data to a standardized format.

The client 130 comprises an electronic device such as a personal computer, a laptop, mobile phone or smartphone, a tablet computer personal digital assistant (PDA) a television set-top box, etc. The client 130 executes a media player that is adapted to play media streams. The media player is also configured to annotate videos with topics. The annotations may be overlaid on top of a video during playback or otherwise presented near the video. The annotation server 110 is configured to assign topics to portions of videos based on transcriptions of the videos and store the assignation of topics. In one embodiment, the video server 120 retrieves the assigned topic information from the annotation server 110 when streaming a video to a client 130. The assigned topic information can then be transmitted all at once or as needed during video playback on the client 130.

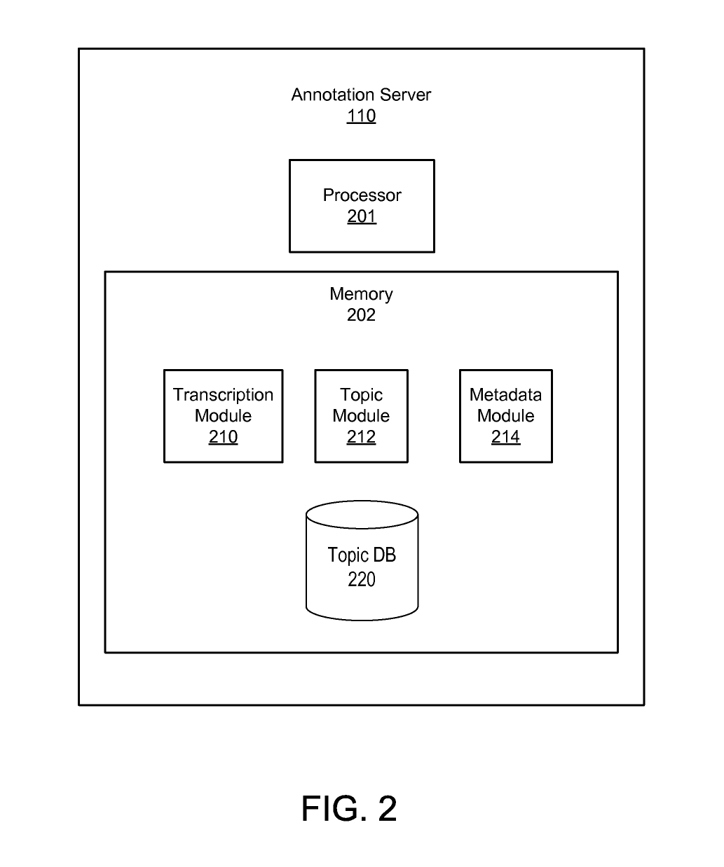

FIG. 2 illustrates a detailed view of an annotation server 110 according to one embodiment. The annotation server 110 comprises a processor 201 and a memory 202 according to one embodiment. The memory 202 (e.g., a non-transitory computer-readable storage medium) stores modules comprising computer-executable program instructions executed by the processor to achieve the functionality attributed to the modules. In one embodiment, the modules in the memory 202 comprise a transcription module 210, a topic module 212, a metadata module 214, and a topic database 220. In alternative embodiments, different or additional components may be included.

The transcription module 210 is configured to transcribe videos stored on the video server 120 in order to facilitate the assigning of topics. In one embodiment, the transcription module 210 retrieves a video from the video server 120 whenever the video is newly added to the video server 120. The transcription module 210 proceeds to transcribe words spoken in the video and generates a transcription of the video. The transcription module 210 may be implemented using, for example, a speech recognition application. Furthermore, in some embodiments, portions of the video may be transcribed manually.

The topic module 212 is configured to analyze the transcription of a video and assign topics to portions of the video. In one embodiment, a topic assigned to a portion of video is selected from a pre-curated or approved list of topics. Approved topics may map to other assets to which a viewer may be directed while watching the video. The topic module 212 identifies a topic and the beginning and end of an associated video portion. For example, a portion of a news show may be tagged “2012 election” based on the transcription corresponding to the tagged portion of the video. In one embodiment, the length of portions of a video is dependent on the length of the video. Each portion of a video may be of uniform length, or dynamically assigned based on the frequency and consistency of keywords in a video transcription.

For example, if movie titles are mentioned over a five minute length portion of a video, the entire five minute portion is assigned the topic “Movies.” On the other hand, if technology is discussed for only a 30 second portion of a video before a change in topics, only the 30 second portion may be assigned the topic “Technology.” In addition, topics may be identified in a portion of video falling within another portion of video. For example, if the “Movies” topic falls within a portion of video from the 5:00 time mark of the video to the 10:00 time mark of the video, a “Star Wars” topic may be tagged in a portion of video from 6:00 to 7:00 and an “Indiana Jones” topic may be tagged in a portion of video from 8:00 to 9:00. Both the parent topic “Movies” and the child topics can be presented to the viewer in the table of contents allowing greater viewing flexibility. Additionally, topics may be manually assigned to portions of a video by an administrator of the annotation server 110. In one embodiment, other video content besides spoken word is considered when assigning topics. Image recognition may be utilized to identify objects in a video and assign a corresponding topic. For example, a basketball game may be visually identified in a portion of a video and assigned the topic “Basketball.”

The metadata module 214 is configured to store the topics and their associated video portions identified by video start points and end points in the topic database 220. In one embodiment, for each assigned topic, the topic database stores the topic name, a portion start point and a portion end point. In another embodiment, the topic database 220 may store the topic name and only the portion start point with the portion duration being a default value. The data stored in the topic database 220 is made accessible to the content server 120 for use when streaming content to one or more of the clients 130.

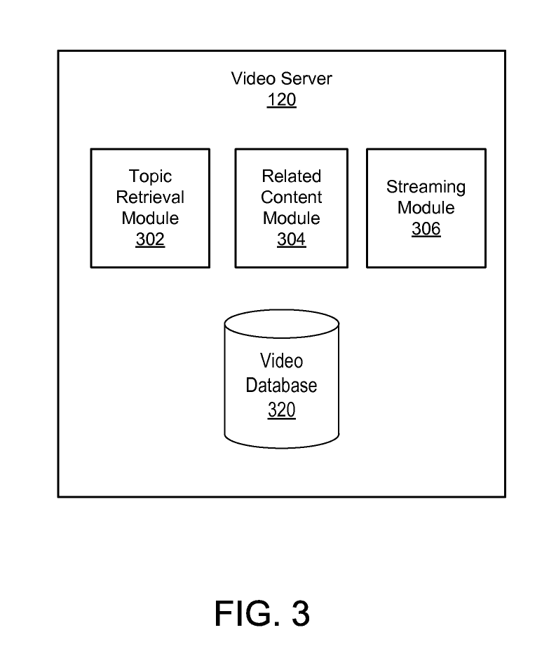

FIG. 3 illustrates a detailed view of the video server 120 according to one embodiment. In one embodiment, the video server 120 comprises a streaming module 306, a topic retrieval module 302, a related content module 304, and a video database 320. In alternative embodiments, different or additional components may be included.

The video database 320 stores media content provided by a content source. The stored media content can include various types of media including television show episodes, movies, sporting events and concerts. In one embodiment, the stored media content may include audio only content such as podcasts or recorded radio content. Whenever a video, or other content, is added to the video database 320, the video is analyzed by the annotation server to assign topics to portions of the added video.

When a video is to be streamed to a client 130, the topic retrieval module 302 retrieves topic information associated with the video from the topic database 220. This allows the video server 120 to transmit topics to the client 130 together with the streaming video and enables the client 130 to display topics when viewing an associated portion of video. After retrieving topic information, the related content module 304 identifies content related to a topic associated with a currently playing portion of the video. For example, if the topic “Movies” is displayed as an annotation during a relevant portion of a video, clicking on or otherwise interacting with the word “Movies” may activate a link to a website featuring movie show times. Similarly, if a name of a piece of hardware or software is displayed as an annotation during a relevant portion of video, interacting with the name may activate a link to a review or preview of the hardware or software. In addition, links may lead the interacting viewer to an advertisement or related video. In alternative embodiments, the links or other related content associated with a topic for a currently playing portion of the video may be displayed directly, without the media player necessarily displaying the topic itself.

In one embodiment, assigning topics is typically performed once by the annotation server 110 when a video is added to the video database 320, but the identification of related content is performed periodically or even each time a video is streamed to a client. This enables the video server 120 to provide content that is up to date and most likely to be relevant to the user.

In one embodiment, sentiment analysis is performed to identify what related content is likely to be of interest to a viewer. For example, if the video topic relates to a product or category of products, the related content may be based on the number of and content of user reviews. For example, in a video discussion about tablet computers, related content may be provided pertaining to the tablet computers that are currently the most reviewed or highest reviewed tablet computers. The sentiment analysis may furthermore include analyzing the recent popularity of potentially related web pages and providing links to popular web pages that are related to the topic. Additionally, the preferences and browsing history of the viewing user may also factor in to which content is linked to through annotated topics. In one embodiment, multiple links to related content may be associated with a single topic via multiple uniform resource locators. For example, rolling over the topic name may cause two or more links to related content to be displayed on the client 130.

Streaming module 306 is configured to fulfill stream requests from a client 130. For example, if the client 130 sends a request for a video stored in the video database 320, the video is streamed to the client 130. In addition, the streaming module 306 transmits topic information including topic names, the location of their associated video portions, and links to related content that has been identified. In one embodiment, the streaming module 306 monitors the current playback location on the client 130 and transmits the topic information that should currently be displayed and/or will soon need to be displayed. In another embodiment, the client 130 may request topic information when needed and identify the current playback location of the video on the client 130 along with the request.

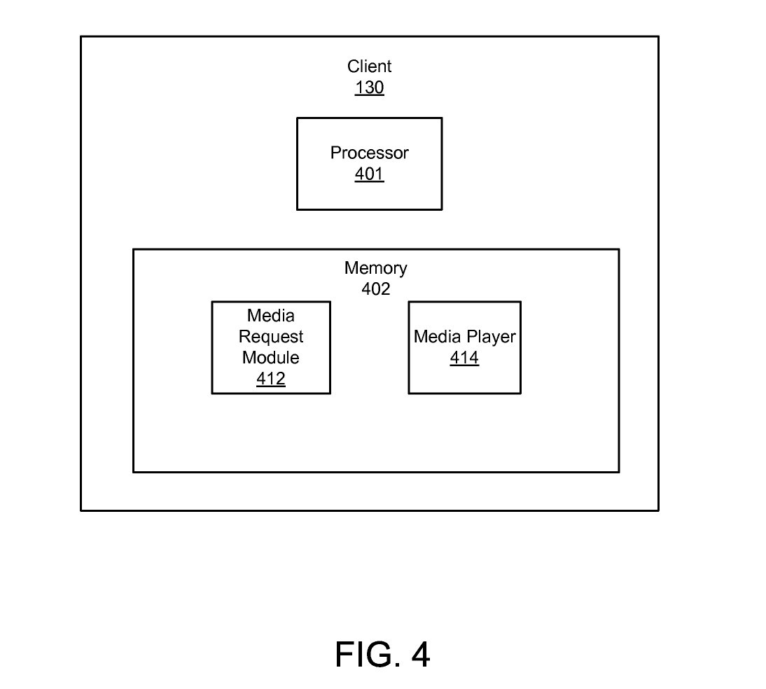

FIG. 4 illustrates a detailed view of a client 130 according to one embodiment. The client 130 comprises a processor 401 and a memory 402 according to one embodiment. The memory 402 (e.g., a non-transitory computer-readable storage medium) stores modules comprising computer-executable program instructions executed by the processor to achieve the functionality attributed to the modules. In one embodiment, the modules in the memory 402 comprise a media request module 412 and a media player 414. In alternative embodiments, different or additional components may be included.

The media player 414 is configured to receive a video stream from the video server 120 and display the video on the client 130. For example, in one embodiment, the media player 414 is embodied as computer program instructions stored to a computer-readable storage medium. When executed, the computer program instructions are loaded in a memory of the client 130 and executed by a processor of the client 130 to carry out the functions of the media player described herein. In one example embodiment, the media player 414 is embedded or otherwise accessed from a mobile application executing on a mobile device. Alternatively, the media player may be an embedded media player within a web page loaded by a web browser. In one embodiment, the modules described herein may be implemented as tabs, windows and web pages included in a web interface or embedded player in a mobile application. In yet another embodiment, the media player may be an application executing on a television set-top box or similar device. In one embodiment, the media player is implemented using Objective C in an HTML 5 environment, although in other embodiments different implementations may be used such as Javascript.

The media request module 412 provides an interface for enabling a user to request media content stored on the video server 120. For example, the media request module 412 may provide a directory of available content (sorted, for example, alphabetically, by category, date, etc.) and/or may provide a search tool for locating content based on keywords. In one embodiment, a user may use the media request module 412 to request content as provided by a content source. For example, television show episodes, movies, sporting events and other media may be requested from the video server 120 in their entirety.

In one embodiment, the media player 414 includes a sliding time bar visually displaying the length of a video and the current playback location within the video. As previously described, the media player 414 is configured to receive topic information associated with a video being displayed from the video server 120. In one embodiment, the topics are displayed as a table of contents of the video currently being viewed. The topics may be listed chronologically or alphabetically and allow the viewer to quickly navigate to the portion of the video associated with the topic. For example, interacting with a topic in the table of contents may cause the media player 414 to jump to the start point of the associated portion of the video. In one embodiment, the media player 414 may jump to a start point a default time value prior to the start point of the portion allowing the viewer to become acclimated or leaving leeway to account for errors by the media player 414 or annotation server 110. The table of contents may be displayed alongside the video being displayed, overlaid on top of the video upon request, or in any other suitable location. In one embodiment, hovering a cursor over a topic presents associated links to related content. While related content is previously described as being identified when topics associated with a video are first retrieved, related content may be identified for a topic only when the user hovers a cursor or otherwise interacts with a topic. For example, related content may not be identified until a viewer requests the related content by interacting with a topic. In one embodiment, hovering over a topic presents other portions of video associated with the topic or other topics associated with the same portion of video. In another embodiment, the video server 110 may detect an interaction with a topic and retrieve related content information.

In addition to being used as a table of contents, topics may be displayed as a “treadmill” of topics. In one embodiment, the media player 414 displays the topics associated the current portion of video, the most recent portion of video and the next portion of video. In an example case, a first topic is associated with a portion from 1:00 to 1:59 of the video, a second topic is associated with a portion from 2:00 to 3:59 of the video, and a third topic is associated with a portion from 4:00 to 4:30 of the video. If the current playback location of the video is 2:50, the topics associated with the first, second, and third portion of video are displayed, with the temporal proximity of each topic identified. For example, topics associated with the current playback location may be located near the vertical or horizontal center of the video, while topics that have already occurred are located near one edge of the video and topics that have yet to occur are located near the opposite edge of the video. Treadmill topics may be displayed as an overlay on top of the video or near the video towards any one of the edges. In another embodiment, only topics associated with portions encompassing the current playback location re displayed. In one embodiment, interacting with a topic in the treadmill links to an associated web page displaying the related content. Visiting related content may result in the related content being opened in a new browser window or tab and/or the playback of the current video pausing.

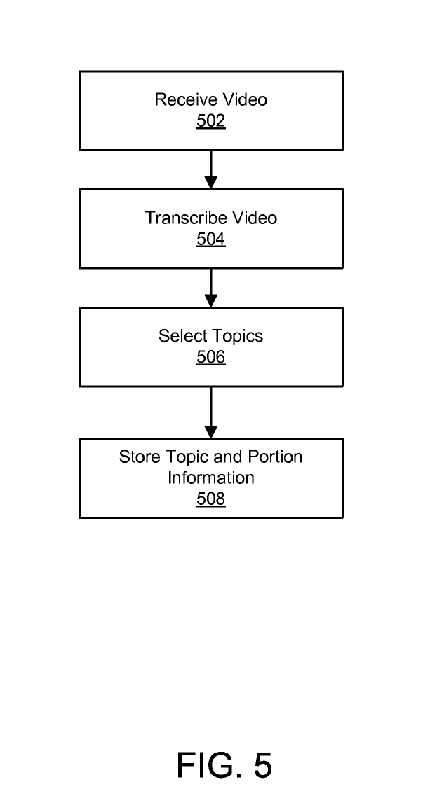

FIG. 5 illustrates an embodiment of a process for selecting topics by the annotation server 110 for playback on a client 130. The annotation server receives 502 a video for analysis. The annotation server transcribes 504 the video. The annotation server selects 506 topics based on the transcription. Each topic is associated with a portion of the received video and each portion has a start point and end point of the received video. Video portions associated with topics may overlap and multiple topics may be assigned to the same video portion. The topic and portion information is stored 508 in the topic database 220 for later retrieval by the video server 120.

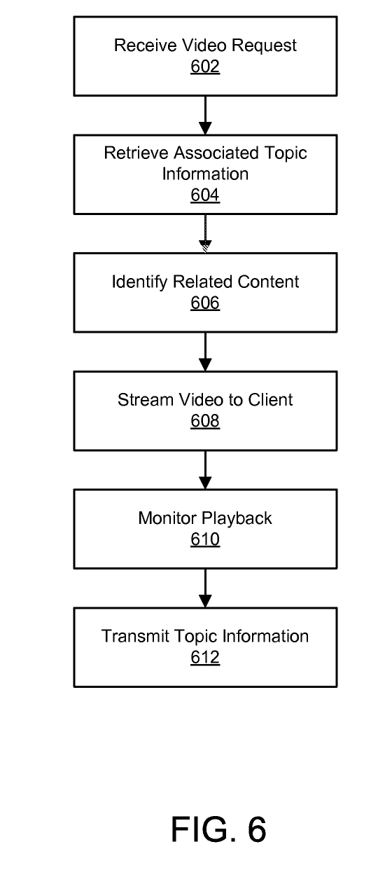

FIG. 6 illustrates an embodiment of a process for streaming videos and associated topic information to a client 130. The video server 110 receives 602 a video request from a client 130. The video server 110 retrieves 604 associated topic information from the topic database 220. The topic information includes topic names which may be displayed with the video content, or otherwise used to select supplemental content for display with the video. Furthermore, the topic information identifies portions of video with which each topic are associated. The video server 110 identifies 606 related content for each of the retrieved topics. In one embodiment, the related content comprises links to content that is related to the associated topic. While topic selection 506 is typically performed once when a video is added to the video database, related content identification may be dynamically generated during each view of the video to reflect current user interest and activity. The video is streamed 608 to the client 130 for playback. The video server 110 monitors 610 the video playback and/or requests from the client 130 to determine what topic information to transmit to the client 130. The video server 110 transmits 612 topic information and related content information to the client 130 based on the monitoring.

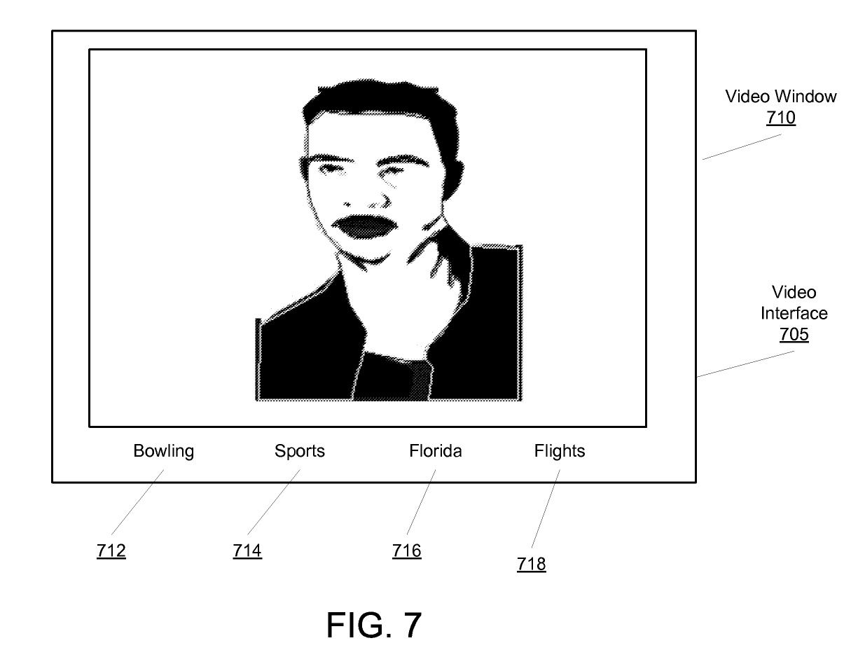

FIG. 7 illustrates an example annotation user interface in accordance with one embodiment. As illustrated, media player 414 displays a video interface 705 on a client 130. A video window 710 displays plays a video for a user of the client 130. Topics names associated with the video content being displayed are displayed along the bottom portion of the video interface 705. For example, topics 712, 714, 716, and 718 (“bowling,” “sports,” Florida,” and “Flights”) are displayed horizontally along the video interface 705. In one embodiment, all topics displayed are associated with the current position of video playback. In another embodiment, a topic “treadmill” displays topics near the horizontal center of the video that are associated with the current playback position. For example, topics 714 and 716 may be associated with the current playback position. Topics listed nearer the edge of the video may be associated with a past or upcoming portion of the video. For example, topic 712 may be associated with a previously displayed portion of the video and topic 718 may be associated with an upcoming portion of the video. In one embodiment, topics associated with past or upcoming portions of the video are identified by adjusting the transparency of the topic names or adjusting the colors of the displayed topic names.

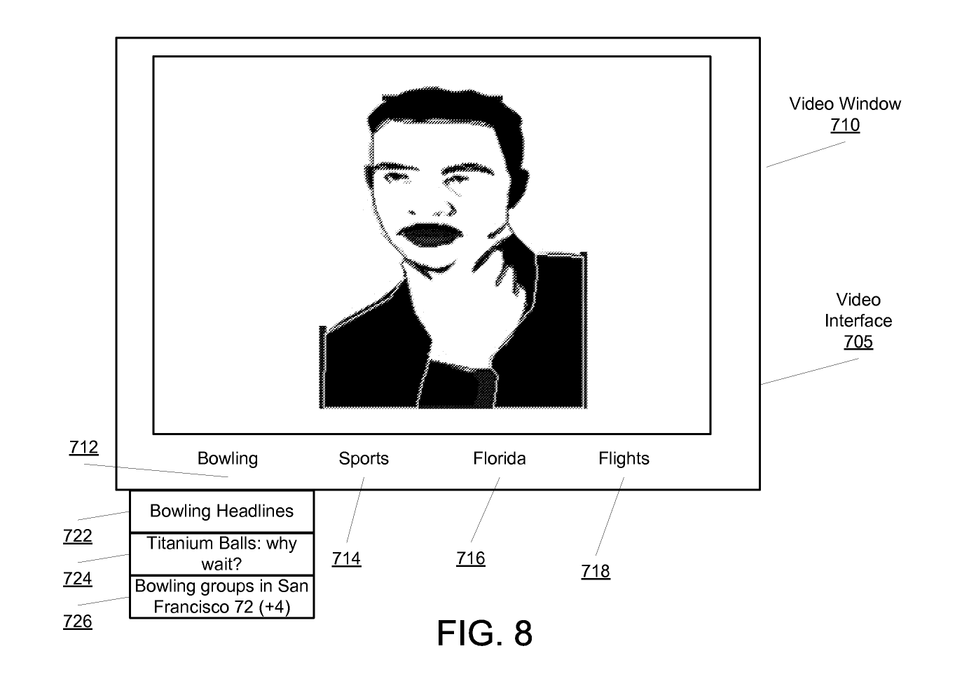

FIG. 8 illustrates an example annotation user interface with mouseover links in accordance with one embodiment. Similarly to FIG. 8, FIG. 7 discloses several topic names 712, 714, 716, and 718 displayed horizontally along the bottom portion of the video interface 705. In one embodiment, hovering a cursor over, or otherwise interacting with, a topic name causes links to additional content to appear. For example, as illustrated, interacting with topic 712 causes links 722, 724, and 726 to appear. In one embodiment, interacting with a link causes a web page to open in another window and pausing playback of the video. The links to additional content may also list a trending score of the additional content. Link 726 lists a trending score of “72” with a recent increase of 4 to the trending score. Listing trending scores can aid a user in determining what has proven helpful to other users. In one embodiment, clicking on a topic name, e.g., “Bowling” while associated content links are displayed will cause the video to jump to the portion of the video associated with “Bowling.” Additionally, in one embodiment, a table of contents may list of all topics in the video, or the topics most likely to be of interest to a user. The table of contents may be displayed adjacent to the video window 710, in a pop up window on top of or adjacent to the video window 710, or accessible via a link that replaces the video window 710 with a table of contents. Interacting with any topics listed in the table of contents causes the media player 414 to jump to the portion of the video associated with the topic. If multiple portions of the video are associated with a topic, an option may be presented to the user of which portion is jumped to, or all portions of the video associated with the topic may be played sequentially.

### Additional Considerations

It is noted that terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the described embodiments. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Upon reading this disclosure, those of skill in the art will appreciate still additional alternative structural and functional designs for providing annotation based video navigation disclosed from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method for providing topic based navigation, the method comprising:
receiving a video and transcribing speech from the video to generate a transcription;
analyzing the transcription to generate a plurality of topics, each of the plurality of topics associated with a portion of the video;
receiving a request for the video from a client computer;
responsive to the request, transmitting the video to the client computer;
monitoring a video playback location of the video as the video plays on the client computer;
determining a topic associated with a current video playback location of the video;
providing for display at the client computer, the topic associated with the current video playback location of the video;
detecting an interaction with the displayed topic associated with the current video playback location on the client computer;
identifying related content information associated with the displayed topic responsive to the interaction; and
transmitting the related content information to the client computer.

2. The method of claim 1, wherein the portion of video is associated with two or more of the plurality of topics.

3. The method of claim 1 further comprising:
providing for display at the client computer a second of the plurality of topics responsive to determining the video playback location is approaching the portion of the video associated with the second of the plurality of topics.

4. The method of claim 1, wherein the related content information comprises a uniform resource locator.

5. A computer-implemented method for providing topic based navigation, the method comprising:
receiving a video and transcribing speech from the video to generate a transcription;
analyzing the transcription to generate a plurality of topics, each of the plurality of topics associated with a portion of the video;
receiving a request for the video from a client computer;
transmitting the video to the client computer;
monitoring a video playback location of the video as the video plays on the client computer; and
providing for display, one of the plurality of topics while the video playback location is within the portion of the video associated with the one of the plurality of topics.

6. The computer-implemented method of claim 5, further comprising:
providing for display at the client computer a second of the plurality of topics responsive to determining the video playback location is approaching the portion of the video associated with the second of the plurality of topics.

7. The computer-implemented method of claim 6, wherein the client computer is configured to display the second of the plurality of topics prior to the video playback location being within the portion of the video associated with the second of the plurality of topics.

8. The computer-implemented method of claim 7, wherein the client computer is configured to display a third of the plurality of topics after the video playback location has passed the portion of the video associated with the third of the plurality of topics.

9. The computer-implemented method of claim 5, further comprising:
determining related content information associated with the one of the plurality of topics; and
transmitting to the client computer the related content information.

10. The computer-implemented method of claim 9, wherein the client is configured to visit a website identified by the related content information responsive to interacting with the one of the plurality of topics.

11. The computer-implemented method of claim 5, further comprising:
providing for display each of the plurality of topics and identification of the portion of the video associated with each of the plurality of topics in a table of contents.

12. The method of claim 11, wherein an interaction from the client computer with one of the plurality of topics causes the client computer to begin playback of the video within the portion of the video associated with the one of the plurality of topics.

13. The method of claim 11, wherein an interaction from the client computer with one of the plurality of topics causes the client computer to identify which portions of the video are associated with the topic.

14. The method of claim 11, wherein the portions of the video associated with a first subset of the plurality of topics are located within a parent portion of the video associated with a parent topic of the plurality of topics.

15. The method of claim 14, wherein an interaction from the client computer with the parent topic causes playback of each of the portions of the video associated with the first subset of the plurality of topics.

16. The method of claim 11, wherein an interaction from the client computer with one of the plurality of topics causes the client computer to visit a website identified by related content information, the related content information associated with the one of the plurality of topics.

17. A non-transitory computer-readable storage medium storing instructions that when executed by a processor cause the processor to perform steps including:
receiving a video and transcribing speech from the video to generate a transcription;
analyzing the transcription to generate a plurality of topics, each of the plurality of topics associated with a portion of the video;
receiving a request for the video from a client computer;
transmitting the video to the client computer;
monitoring a video playback location of the video as the video plays on the client computer; and
providing for display, one of the plurality of topics while the video playback location is within the portion of the video associated with the one of the plurality of topics.

18. The non-transitory computer-readable storage medium of claim 17, the instructions further causing the processor to perform steps including:
providing for display at the client computer a second of the plurality of topics responsive to determining the video playback location is approaching the portion of the video associated with the second of the plurality of topics.

19. The non-transitory computer-readable storage medium of claim 18, wherein the client computer is configured to display the second of the plurality of topics prior to the video playback location being within the portion of the video associated with the second of the plurality of topics.

20. The non-transitory computer-readable storage medium of claim 17, the instructions further causing the processor to perform steps including:
providing for display each of the plurality of topics and identification of the portion of the video associated with each of the plurality of topics in a table of contents.
